(19) United States
(12) Patent Application Publication
(10) Pub. No.: US 2022/0398618 A1
(43) Pub. Date: Dec. 15, 2022

(54) A METHOD FOR SETTING UP USER CREATED STOREFRONTS WITHIN A PRODUCT TREE BASED MULTI-LEVEL MARKETING SYSTEM

(71) Applicant: KwikClick, LLC, Murray, UT (US)

(72) Inventor: Fred Cooper, Farmington, UT (US)

(21) Appl. No.: 17/825,963

(22) Filed: May 26, 2022

Related U.S. Application Data
(60) Provisional application No. 63/193,251, filed on May 26, 2021.

(51) Int. Cl. G06Q 30/02

(52) U.S. Cl. CPC G06Q 30/0214; G06Q 30/0277

(57) ABSTRACT

Disclosed herein is a system and method to allow sellers of products to enroll an individual product in a multi-level marketing (MLM) system by providing the MLM system with a seller and a product to be sold and provides a first purchaser to purchase that product and then allow the purchaser to enroll themselves in the MLM system as well as to allow the purchaser of a single product to easily advertise the product to a second purchaser. The second purchaser can do the same, by purchasing the product and advertising to a third purchaser and so on. The number of purchasers (downline) from a single product may be limited by a preset amount based upon commission levels. The commissions are paid out to first purchaser and all the downlines, where the commission is reduced as it is paid out down the line. Once the purchasers are enrolled, they are provided with a code and link to the purchased product to allow the purchasers to pass the code and the link onto the user's followers, such as family, friends, colleagues, etc. to allow them to become part of the MLM tree. *The system allows for users to then create a storefront which is populated with items they have purchased in the past and are eligible to receive commission for distributing. Visitors to the storefront may purchase the items and if so the user the storefront belongs to is automatically the direct upline of those new users. The item order is then either filled out by the user the storefront belongs to or is sent off to a 3rd party which has the item in stock. Storefronts can be created by any user and could also be fully customizable by the user to better advertise to the user's target demographic. Some 3rd parties may also allow their items to be “white label” meaning the user can rebrand the item with their own trademarks.

### CROSS-REFERENCE TO RELATED APPLICATION

The present application claims the priority benefit of U.S. provisional application No. 63/193,251 filed May 26, 2021, the disclosure of which is incorporated herein by reference.

### FIELD OF THE DISCLOSURE

The present disclosure is generally related to multi-level marketing systems and commissions offered to users.

### BACKGROUND

A Multilevel marketing (MLM) system is a sales strategy used by some direct sales companies, which is used to encourage existing distributors to recruit new distributors who are paid a percentage of their recruits' sales. The recruits are the distributor's “downline.” Distributors also make money through direct sales of products to customers. Amway, which sells health, beauty, and home care products, is an example of a well-known direct sales company that uses multilevel marketing.

Multilevel marketing is a legitimate business sales strategy. One problem is that the MLM is organized as a pyramid tree. However, pyramid “schemes” that use money from new recruits to pay people at the top rather than those who perform the work is illegal. These pyramid schemes involve taking advantage of people by pretending to be engaged in legitimate multilevel or network marketing. You can spot pyramid schemes by their greater focus on recruitment than on product sales.

One issue in determining the legitimacy of a multilevel marketing company is whether it sells its products primarily to consumers or to its members who must recruit new members to buy their products. If it is the former, the company is likely a legitimate multilevel marketer. If it is the latter, it could be an illegal pyramid scheme.

Although each MLM company dictates its own specific financial compensation plan for the payout of any earnings to their respective participants, the common feature that is found across all MLMs is that the compensation plans theoretically pay out to participants only from two potential revenue streams. The first is paid out from commissions of sales made by the participants directly to their own retail customers. The second is paid out from commissions based upon the wholesale purchases made by other distributors below the participant who have recruited those other participants into the MLM; in the organizational hierarchy of MLMs, these participants are referred to as one's down line distributors.

MLM salespeople (distributors) are, therefore, expected to sell products directly to end-user retail consumers by means of relationship referrals and word of mouth marketing, but most importantly they are incentivized to recruit others to join the company's distribution chain as fellow salespeople so that these can become down line distributors.

*Members of an MLM system act as distributors for that system, but unlike traditional retail distributors, MLM members usually have to rely on personal connections to distribute product instead of a public facing storefront. *Members of an MLM system could take it upon themselves to create a public storefront, but this may be difficult because of the time and costs of doing so. *Further most MLM members are not retailing a product from a third party but are often selling membership to the MLM which is a single product which often has no repeat purchase, and a storefront is unnecessary. *This system allows the MLM users to create an avenue to reach new buyers outside of their existing social networks. It also allows recurring buyers to purchase products from a familiar storefront and view other items that the user has bought and placed in their storefront which the user may not have advertised to that potential buyer.

### DESCRIPTIONS OF THE DRAWINGS

FIG. 1: Illustrates a Multi-Level Marketing System.

FIG. 2: Illustrates an Admin Network Base Module.

FIG. 3: Illustrates an Admin Network Calculation Module.

FIG. 4: Illustrates an Admin Network Commission Module.

FIG. 5: Illustrates an Admin Network Advertising Module.

FIG. 6: Illustrates an Admin Network Admin Database.

FIG. 7: Illustrates an Admin Network Vendor Module.

FIG. 8: Illustrates an Admin Network Compensation Database.

FIG. 9: Illustrates an Admin Network Code Database.

FIG. 10: Illustrates an Admin Network Store Stocking Module.

FIG. 11: Illustrates a User Device Purchase Module.

FIG. 12: Illustrates a User Device User Database.

FIG. 13: Illustrates a User Device Downline Module.

FIG. 14: Illustrates a User Device Store Setup Module.

FIG. 15: Illustrates a 3rd Party Network 3rd Party Base Module.

FIG. 16: Illustrates a 3rd Party Network Admin Module.

FIG. 17: Illustrates a 3rd Party Network Discount Module.

FIG. 18: Illustrates a 3rd Party Network 3rd Party Database.

FIG. 19: Illustrates a User Storefront Store Module.

FIG. 20: Illustrates a User Storefront Store Database.

### DETAILED DESCRIPTION

FIG. 1 is a system for a Multi-Level Marketing System. This system comprises of *an Admin Network which includes an Admin Network Base Module 104, Admin Network Calculation Module 106, Admin Network Commission Module 108, Admin Network Advertising Module 110, Admin Network Admin Database 112, Admin Network Vendor Module 114, Admin Network Compensation Database 116, an Admin Network Code Database 118, and an Admin Module Store Stocking Module. In some embodiments, a distributor may refer to the non-salaried workforce selling the company's products or services, while the earnings of the participants are derived from a pyramid-shaped or binary compensation commission system. In some embodiments, a product may refer to an article or substance that is manufactured or refined for sale. In some embodiments, a service may refer to a system supplying a public need such as transport, communications, or utilities such as electricity or water. A service may be an act of dealing with a customer in a store, restaurant, or hotel by taking their orders, showing, or selling them goods. Additionally, a service may be work that someone does or time that someone spends working for an organization, or a business that offers a particular type of help or work. In some embodiments, an MLM tree or commission tree may refer to the payment structure in which commissions are given out. In some embodiments, a MLM system may be referred to as network marketing which may be a business model that depends on person-to-person sales by independent representatives, often working from home. A network marketing business may require the independent representatives to build a network of business partners or salespeople to assist with lead generation and closing sales. In some embodiments, end of life of MLM tree may refer to the end of the MLM tree in which further participants in the MLM will not receive a commission, the commission tree starts up again, or the commission tree is restructured in some form. In some embodiments, an existing MLM system may refer to currently existing or established companies that use the sales strategies to encourage existing distributors to recruit new distributors who are paid a percentage of their recruits' sales. In some embodiments, the Admin Network may include data security as well as an MLM algorithm and may be able to connect to the app store. In some embodiments, data security may refer to the process of protecting data from unauthorized access and data corruption throughout its lifecycle. Data security may include data encryption, tokenization, and key management practices that protect data across all applications and platforms. In some embodiments, MLM algorithm may refer to the calculation performed using the compensation decay rate in order to calculate the commissions for downline participants. In some embodiments, connect app store refers to connecting the app store to an MLM system, at element 102. An Admin Network Base Module 104 which connects to the 3rd Party Network 3rd Party Base Module 140, initiates the Admin Network Vendor Module 114 and initiates the Admin Network Calculation Module 106. The 3rd Party Network 3rd Party Base Module 140 is the module that interacts with the sellers and the Admin Network Vendor Module 114 is the module that is loaded on the seller's computers system, at element 104. An Admin Network Calculation Module 106 which is initiated by the Admin Network Base Module 104, extracts the discount received from the 3rd Party Network 3rd Party Base Module 140 as well as the compensation plan or commission plan (e.g. its decay rate or commission structure so that each downline gets less and less commission) in order to determine the commissions for the MLM (Multi-Level Marketing) tree and stores the data in the Admin Network Compensation Database 116. In some embodiments, a commission may refer to a payment to someone who sells goods that is directly related to the amount sold, or a system that uses such payments. In some embodiments, a compensation plan or a commission plan may refers to the decay rate of the commissions provided to the MLM system from the discount offered by the 3rd Party, the 3rd Party also selects the decay rate in order to calculate the commissions offered to the first purchaser as well as the percentage offered to the downline participants, at element 106. *An Admin Network Commission Module 108 which is continuously polling for the user data (the user being the product purchaser/distributor) from the 3rd Party Network Discount Module 144 or from a User Storefront Store Module 150 and once it receives the data the Admin Network Commission Module 108 uses the data stored in the Admin Network Compensation Database 116 to determine the downline and upline commissions for the other users (product purchasers/distributors) within the MLM tree, and then initiates the Admin Network Advertising Module 110. In some embodiments, an upline may refer to the MLM distributors that recruits work for as salespeople to sell the products or services. In some embodiments, a downline may refer to the recruits the MLM distributors are able to secure as participants in the MLM system. In some embodiments, downline trees may go across country boundaries which may be the ability to pay out commissions for an MLM tree even though the participants in the MLM tree may not reside in the same country. In this case the commissions would need to be calculated for the appropriate exchange rate to ensure participants are paid in their residing countries currency in the correct amount, at element 108. An Admin Network Advertising Module 110, which is initiated by the Admin Network Commission Module 108, determines the user's (product purchasers/distributors) sphere of influence or contact list in order to provide the user's potential downline purchasers/distributors with a link and a code for the potential downline purchasers/distributors to become part of the MLM tree, at element 110. An Admin Network Admin Database 112, which is created through the Admin Network Vendor Module 114 (seller of a product), contains the data received from various 3rd Parties (various sellers) that are part of the MLM, the data may contain an item ID, description of the item, the original cost of the item, the discount for the item, the cost of the item with the discount, the compensation plan decay rate and a link to the item. In some embodiments, advertising link may refer to a link that directs a consumer to a product, service or good, at element 112. An Admin Network Vendor (those selling products) Module, which is initiated by the Admin Network Base Module 104, receives the data from the 3rd Party Network, stores the data in the Admin Network Admin Database 112, creates a link for the item and sends the link back to the 3rd Party Network and returns to the Admin Network Base Module 104, at element 114. An Admin Network Compensation Database 116, which is created through the Admin Network Calculation Module 106 and contains the various commissions for the different product purchasers/distributors, at element 116. An Admin Network Code Database 118 which contains the codes given to the product purchasers/distributors (users) for the product purchasers/distributors (user) to pass the code to their potential purchasers/distributors to advertise or promote the item that the user has purchased, at element 118. *An Admin Network Store Stocking Module 120 which polls for a user ID and request for data from the User Device Store Setup Module 134, checks the Admin Network Code Database 118 for that user ID, extracts all the item IDs and codes from matching entries, returns the Item IDs and associated codes to the User Device Store Setup Module 134, polls for which items the user selects for their store, creates a User Storefront with those items in stock, and sends a link to the user's User Storefront, this allows the user to set up a store and populate it with items of their choice that they have bought in the past, in some embodiments the user need not have bought an item to add that item to the User Storefront, at element 120. The Cloud or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance, at element 122. A User (product purchasers/distributors) Device such as a laptop, smartphone, table, computer, or smart speaker, at element 124. The User Device Comms or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance, at element 126. A User Device Purchase Module 128 which connects to the 3rd Party Network, allows a purchaser/distributor to select an item and the associated link, determines if the purchaser/distributor entered a code, and sends the link and code, if available, to the 3rd Party Network, at element 128. A User Device User Database 130 which contains the user's (product purchasers/distributors) followers (sphere of influence) as well as the followers contact information in order for them to receive commissions on their purchases. In some embodiments, a distributor contact list or followers may refer to the recruits or followers on social media that a distributor has secured to participant in their downline. In some embodiments, the User Device User Database 130 may include ratings and recommendations from the users. In some embodiments, rating and recommendation modules may refer to modules in which a company, entity, or person provides ratings and/or recommendations for products, goods, or services, at element 130. A User Device Downline Module 132 which is continuously polling to receive the code and link from the Admin Network Advertising Module 110 to allow the purchaser/distributor to pass the code and link to the user's followers stored in the User Device User Database 130, at element 132. *A User Device Store Setup Module 134 which sends the user's user ID to the Admin Network Store Stocking Module 120, receives data on which items the user can list in their store, allows the user to choose which items will be listed in the store, sends the selected items to the Admin Network Store Stocking Module 120, and receives a link to the newly set up User Storefront, at element 134. A 3rd Party Network which is the various 3rd Parties, such as retail stores including stores that sell product consumables, services, franchises, service networks, large box stores, or e-commerce sites that allow e-commerce sales and may include an e-commerce shopping cart, that offer items to users at a discount, such as a product discount, in order to use MLM. In some embodiments, a franchise may refer to an authorization granted by a government or company to an individual or group enabling them to carry out specified commercial activities, e.g. providing a broadcasting service, or acting as an agent for a company's products. In some embodiments, product consumables may refer to goods by individuals and businesses that must be replaced regularly because they wear out or are used up. In some embodiments, service networks refer to a collection of people and information brought together on the internet to provide a specific service or achieve a common business objective, such as Angie's List. In some embodiments, e-commerce sale may refer to sales of goods and services where the business takes place over the internet, an extra-net, Electronic Data Interchange (EDI), or other online system. Payment may or may not be made online. Business in this context is defined as an order placed by the buyer or price and terms of sale negotiated. In some embodiments, e-commerce shopping cart may refer to a software used in E-commerce to assist visitors to make purchases online. Upon checkout, the software calculates the total of the order, including shipping and handling, taxes, and other parameters the owner of the site has previously set. In some embodiments, retailer may refer to a person or business that sells goods to the public in relatively small quantities for use or consumption rather than for resale. In some embodiments, product discounts may refer to a reduce price or something being sold at a price lower than that item is normally sold for. It is a reduction to a basic price for a good or service. In some embodiments, large box stores may refer to a physically large retail establishment, usually part of a chain of stores, offers a variety of products to its customers. The term sometimes refers, by extension, to the company that operates the store, and may be referenced as a supercenter, superstore, megastore, etc. These stores achieve economies of scale by focusing on large sales volumes. Because volume is high, the profit margin for each product can be lowered, which results in very competitively priced goods. The term “big-box” is derived from the store's physical appearance, at element 136. The 3rd Party Network Comms or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance, at element 138. A 3rd Party Network 3rd Party Base Module 140 which initiates the 3rd Party Network Admin Module 142, continuously polls for the user to select a link, receives the purchaser/distributor data, and initiates the 3rd Party Network Discount Module 144, at element 140. A 3rd Party Network Admin Module 142 which is initiated from the 3rd Party Network Base Module, connects to the Admin Network, sends the data for the items to be purchased, receives a link from the Admin Network, stores the link in the 3rd Party Network Database and returns to the 3rd Party Network 3rd Party Base Module 140, at element 142. A 3rd Party Network Discount Module 144 which is initiated from the 3rd Party Network 3rd Party Base Module 140, extracts the link and compares it to the 3rd Party Network 3rd Party Database 146 to extract the corresponding discount for the selected item, the discount is applied to the user order and it is determined if the user entered a code or not, the order is processed and the process returns to the 3rd Party Network 3rd Party Base Module 140, at element 144. A 3rd Party Network 3rd Party Database 146 which contains information about the item the 3rd Party selects to offer at a discount for the Admin Network. In some embodiments, the 3rd Party Network 3rd Party Database 146 may include local media for the product or service. In some embodiments, local media may refer to the various types of media, such as photos, videos, text, sounds, haptics, online product descriptions, etc. for enhanced marketing, at element 146. *A User Storefront which may be a website, web page, application, location within an app or web page, a physical store, or any other type of store where people can shop, purchase tangible goods, rent movies, songs, video games, accessories, artwork, or digital content such as images or files, a digital store may be comprised of several different pages or locations online which are linked together, in an embodiment the digital store is more than one part of the webpage or store, in some embodiments when certain functions are required to complete the activities at a digital store, a web server links the User Storefronts 1-N to modules that are used by all User Storefronts, in some embodiments, the web server interfaces with the web browser, which is a computer application that accesses the web site, at element 148. *A User Storefront Store Module 150 which displays the items in the User Storefront Store Database 152 to visitors via the User Storefront Store GUI and allows those visitors to select an item to purchase, then User Storefront Store Module 150 processes the purchase and sends the code associated with the item to the Admin Network Commission Module 108, at element 150. *A User Storefront Store Database 152 which contains data on items to be displayed in the store which includes an item ID, price, and referral code, in some embodiments the database may also include marketing materials such as pictures, descriptions, and specs of the items, at element 152. *A User Storefront GUI, or graphical user interface, which is an interface that allows visitors to the User Storefront to browse which items are for sale, and purchase items from the User Store, in some embodiments the GUI may also allow the user to view pictures, details, reviews, shipping costs, etc. of an item, at element 154.

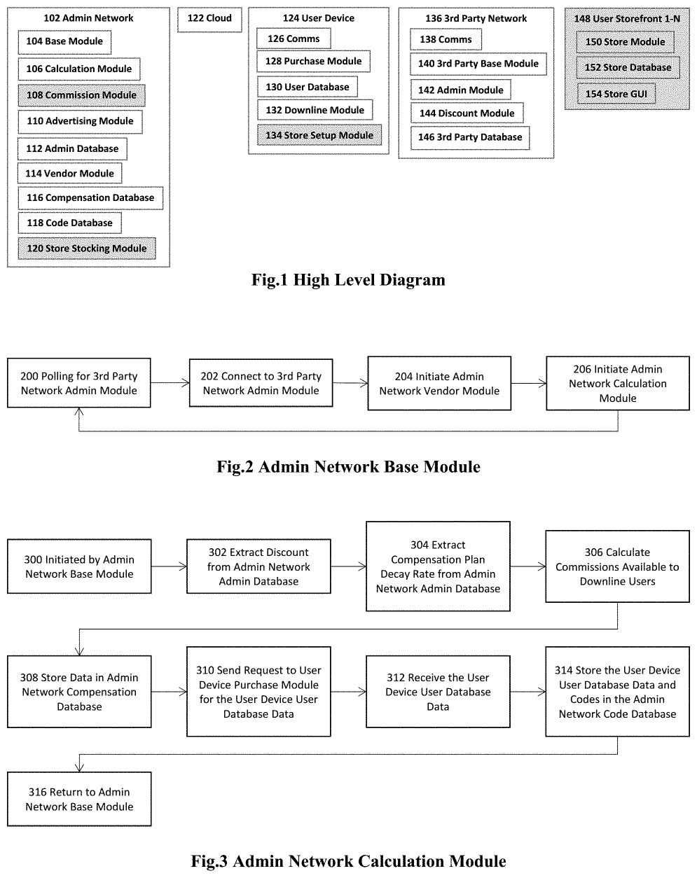

Functioning of the Admin Network Base Module 104 will now be explained with reference to FIG. 2. The process begins with the Admin Network Base Module 104 continuously polls for the 3rd Party Network Admin Module 142 (sellers of products), at step 200. The Admin Network Base Module 104 connects to the 3rd Party Network Admin Module 142 (sellers of products), at step 202. Once the Admin Network Base Module 104 connects to the 3rd Party Network Admin Module 142 the Admin Network Base Module 104 initiates the Admin Network Vendor Module 114, at step 204. Then the Admin Network Base Module 104 initiates the Admin Network Calculation Module 106 and the process returns to step 200, at step 206.

Functioning of the Admin Network Calculation Module 106 will now be explained with reference to FIG. 3. The process begins with the Admin Network Base Module 104 initiating the Admin Network Calculation Module 106, at step 300. The Admin Network Calculation Module 106 extracts the discount from the Admin Network Admin Database 112, which is received from the 3rd Party Network, at step 302. Then the Admin Network Calculation Module 106 extracts the compensation plan decay rate from the Admin Network Admin Database 112, at step 304. The Admin Network Calculation Module 106 determines the commissions available to the downline users, or the followers of the user that purchased the item. In some embodiments, the commissions may be calculated by using the discount on the item and providing 50% of the discount to the first participant and then the remaining amount of the discount for the downline users at a 50% decay rate. For example, if the first user purchased an item that was originally $59.00 discounted by 15%, the first user to make the purchase would receive $3.32 or 50% of the discount. Then any follower of the user who made the initial purchase would receive 50% of the remaining discount or 50% of $3.32, and this may continue until there is only one cent left to pay out as a commission for the downline users, at step 306. Then the Admin Network Calculation Module 106 stores the data in the Admin Network Compensation Database 116, at step 308. The Admin Network Calculation Module 106 sends a request to the User Device Purchase Module 128 for the data stored in the User Device User Database 130, at step 310. Then the Admin Network Calculation Module 106 receives the User Device User Database 130 data from the User Device Purchase Module 128, at step 312. The Admin Network Calculation Module 106 stores the received data, as well as the code data, in the Admin Network Code Database 118, at step 314. The Admin Network Calculation Module 106 then returns to the Admin Network Base Module 104, at step 316.

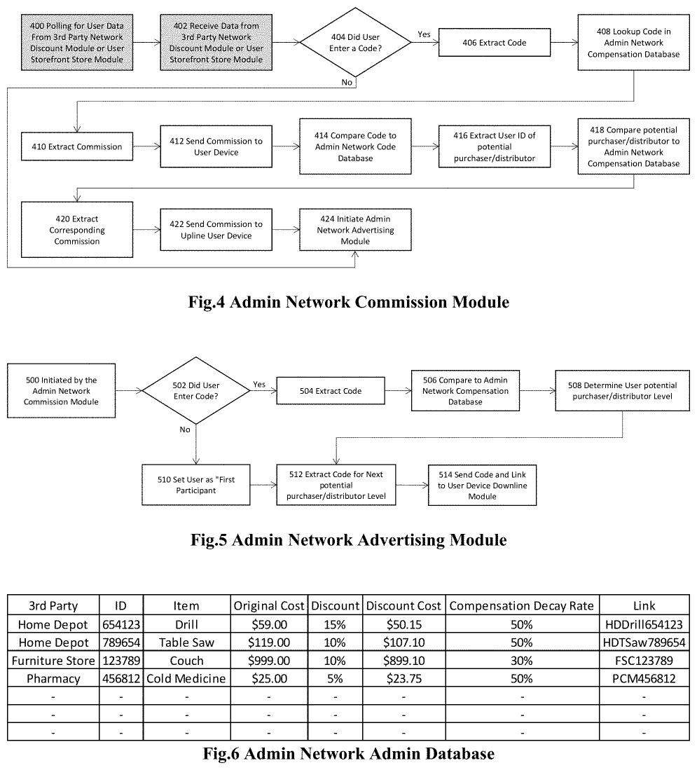

Functioning of the Admin Network Commission Module 108 will now be explained with reference to FIG. 4. *The process begins with the Admin Network Commission Module 108 continuously polling for the user data from the 3rd Party Network Discount Module 144 or from a User Storefront Store Module 150, at step 400. *The Admin Network Commission Module 108 receives the user data from the 3rd Party Network Discount Module 144 or from a User Storefront Store Module 150, at step 402. *Then the Admin Network Commission Module 108 determines if the user entered a code, in the case of a purchase made from a User Storefront, the code is entered automatically because the user who setup the User Storefront will be the upline user, at step 404. If the user did enter a code the Admin Network Commission Module 108 extracts the code the user entered, at step 406. The extracted code is then looked up in the Admin Network Compensation Database 116 which contains the various commissions for the different sphere of influence or potential product purchasers/distributors levels as well as the associated code for each of the different sphere of influence levels, at step 408. Then the Admin Network Commission Module 108 extracts the corresponding commission for the code that was looked up in the Admin Network Compensation Database 116, at step 410. The Admin Network Commission Module 108 sends the commission to the user (purchaser/distributor). In some embodiments, the Admin Network Commission Module 108 may track profits and payments as well as track taxes for users enrolled in the MLM system. In some embodiments, track profits and payments may refer to the MLM system tracking the profits of the MLM and tracking the payments or commissions paid out to participants. In some embodiments, track taxes may refer to tracking the commissions provided to participants for tax purposes, at step 412. Then the Admin Network Commission Module 108 compares the extracted code to the Admin Network Code Database 118 which contains the list of users and the code sent to the user's followers, at step 414. The Admin Network Commission Module 108 extracts the user ID and sphere of influence or potential purchaser/distributor by using the extracted code, at step 416. Then the Admin Network Commission Module 108 compares the extracted sphere of influence or potential purchaser/distributor to the Admin Network Compensation Database 116, at step 418. The Admin Network Commission Module 108 uses the extracted sphere of influence to extract the corresponding commission from the Admin Network Compensation Database 116, at step 420. The Admin Network Commission Module 108 sends the commission to the upline user, at step 422. If the user did not enter a code, the Admin Network Commission Module 108 initiates the Admin Network Advertising Module 110, at step 424.

Functioning of the Admin Network Advertising Module 110 will now be explained with reference to FIG. 5. The process begins with the Admin Network Commission Module 108 initiating the Admin Network Advertising Module 110, at step 500. The Admin Network Advertising Module 110 determines if the user entered a code, at step 502. If it is determined that the user entered a code the code is extracted, at step 504. The Admin Network Advertising Module 110 compares the extracted code to the Admin Network Compensation Database 116, at step 506. The Admin Network Advertising Module 110 determines the user's sphere of influence level, at step 508. If it is determined that the user did not enter a code then the Admin Network Advertising Module 110 sets the user as the “First Participant”, at step 510. Then the Admin Network Advertising Module 110 extracts the code for the next sphere of influence level or potential purchaser/distributor in order to provide the user's followers with a code that would allow them to join the Multi-Level Marketing tree, at step 512. The Admin Network Advertising Module 110 sends code and the link to the item to the User Device Downline Module 132, at step 514.

Functioning of the Admin Network Admin Database 112 will now be explained with reference to FIG. 6. This figure displays the Admin Network Admin Database 112 which is created through the Admin Network Vendor Module 114. The Admin Network Vendor Module 114 receives the item data from the 3rd Party Network, creates a link for the item, stores the data in the Admin Network Admin Database 112 and sends the created link back to the 3rd Party Network. The Admin Network Admin Database 112 contains the data collected from various 3rd Parties that enrolled in the Multi-Level Marketing System. The Admin Network Admin Database 112 contains the name of the 3rd Party, the ID for the item, an description of the item, the original cost of the item, the discount provided by the 3rd Party, the cost of the item with the discount, the compensation decay rate or how the downline commissions are calculated, and the link to the item. In some embodiments, the Admin Network Admin Database 112 may include communicating events with the downlines and uplines, dynamic incentives and rewards for a product, marketing materials, banking referrals, materials for suggestive selling, etc. In some embodiments, communicate events with downlines and uplines refer to advertising events to participants in an MLM system. In some embodiments, dynamic incentives and rewards for a product may refer to incentives or rewards that are continuously updated for a product. In some embodiments, marketing materials may refer to a means of marketing, advertising or promotional materials developed by or for license (or subject to licensee's approval) that promote the sale of the licensed product, including but not limited to, television, radio and online advertising, point of sale materials (e.g. posters, counter-cards), packaging advertising, print media and all audio or video media. In some embodiments, banking referral may refer to a structured flow of collecting and organizing referrals for banks. Businesses who have been unsuccessful in a credit application process with a bank will be asked for their permission to have their financial information passed to designated finance platforms who can contact the business in a regulated time-frame. In some embodiments, suggestive selling may refer to a sales technique where an employee asks a customer if they would like to include an additional purchase or recommends a product which might suit the client.

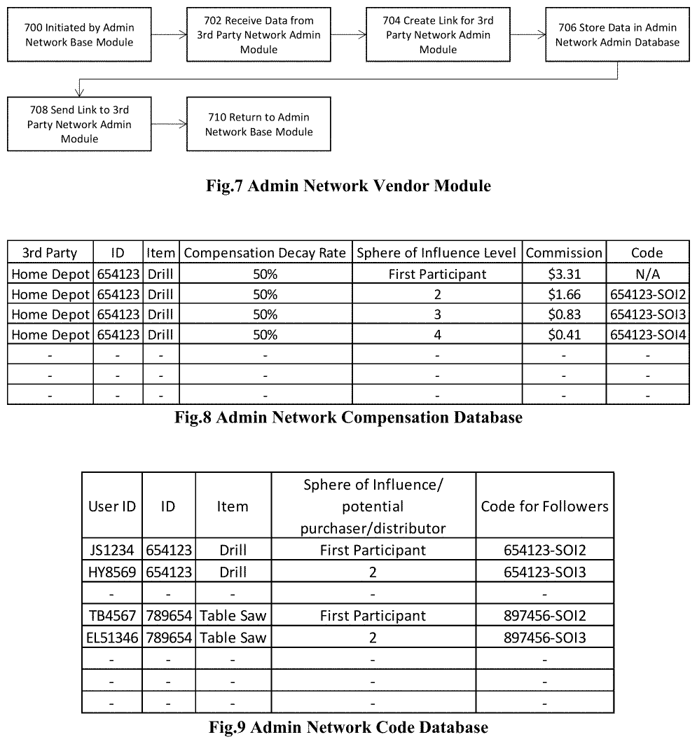

Functioning of the Admin Network Vendor Module 114 will now be explained with reference to FIG. 7. The process begins with the Admin Network Base Module 104 initiating the Admin Network Vendor Module 114, at step 700. The Admin Network Vendor Module 114 receives the data from the 3rd Party Network Admin Module 142 which may include the item to be enrolled in the MLM system, the original cost of the item, the discount provided by the 3rd Party, the cost of the item with the discount, the compensation plan decay rate, etc., at step 702. Then the Admin Network Vendor Module 114 creates a link for the item for the 3rd Party Network Admin Module 142. A vendor is a seller of a product, such as a retailer, at step 704. The Admin Network Vendor Module 114 stores the received data and the created link in the Admin Network Admin Database 112, at step 706. The Admin Network Vendor Module 114 sends the link to the 3rd Party Network Admin Module 142, at step 708. The Admin Network Vendor Module 114 returns to the Admin Network Base Module 104, at step 710.

Functioning of the Admin Network Compensation Database 116 will now be explained with reference to FIG. 8. This figure displays the Admin Network Compensation Database 116 which is created through the Admin Network Calculation Module 106. The Admin Network Calculation Module 106 extracts the discount and the compensation plan decay rate in order to calculate the downline commissions for additional users and the various sphere of influence levels are stored in the Admin Network Compensation Database 116. The Admin Network Compensation Database 116 contains the 3rd Party, the ID for the item, the item, the compensation plan decay rate, the various sphere of influence levels, the commission for each sphere of influence level and the code to be used by the user's followers to enroll in the MLM system. In some embodiments, the Admin Network Compensation Database 116 may include a lottery structure for how the commissions are paid to users or freelancers. In some embodiments, lottery may refer to a process or thing whose success or outcome is governed by chance. A means of raising money by selling number tickets and giving prizes to the holders of number drawn at random. In some embodiments, freelancers may refer to a person who works as a writer, designer, performer, or the like, selling work or services by the hour, day, job, etc., rather than working on a regular salary basis for one employer.

Functioning of the Admin Network Code Database 118 will now be explained with reference to FIG. 9. The Admin Network Code Database 118 which is used to determine the sphere of influence of the purchaser/distributor from the code that was used when a purchaser/distributor purchased a product or item from a 3rd Party. The Admin Network Code Database 118 contains User ID, ID, Item, Sphere of Influence/potential purchaser/distributor, and Code for Followers.

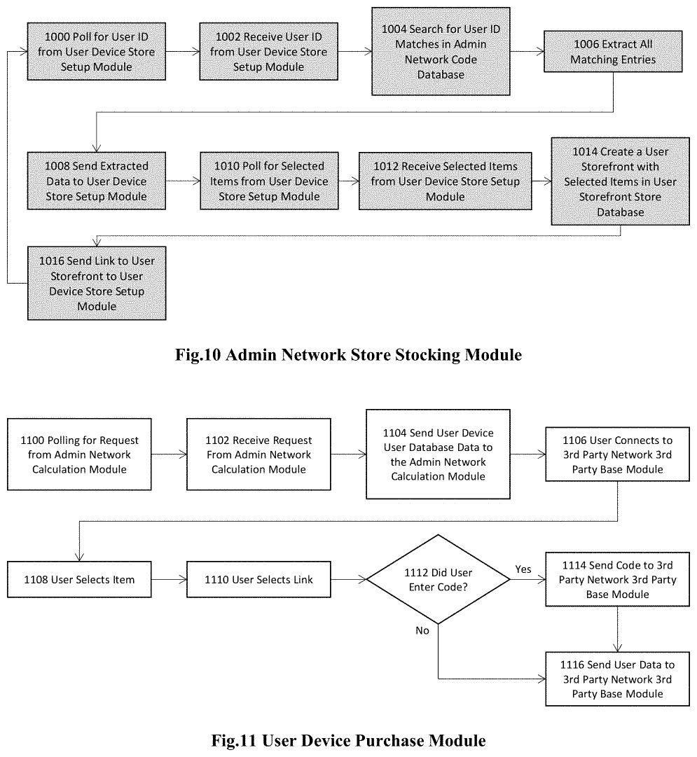

Functioning of the Admin Network Store Stocking Module 120 will now be explained with reference to FIG. 10. *The process begins with the Admin Network Store Stocking Module 120 polling for a user ID from the User Device Store Setup Module 134, at step 1000. *The Admin Network Store Stocking Module 120 receives the user ID from the User Device Store Setup Module 134, in some embodiments more information may be sent from the User Device Store Setup Module 134, for example, a store name, store layout, or other store settings, at step 1002. *The Admin Network Store Stocking Module 120 searches for entries with matching user IDs in the Admin Network Code Database 118 to identify which items the user has purchased in the past, in embodiments where the user is able to display items in their store without purchasing those items this step may be skipped, at step 1004. *The Admin Network Store Stocking Module 120 extracts all matching entries from the Admin Network Code Database 118, at step 1006. *The Admin Network Store Stocking Module 120 sends the extracted data to the User Device Store Setup Module 134 so that the user can select which items to list in the store, at step 1008. *The Admin Network Store Stocking Module 120 polls for the user's item selection from the User Device Store Setup Module 134, at step 1010. *The Admin Network Store Stocking Module 120 receives the user's selection of items from the User Device Store Setup Module 134, at step 1012. *The Admin Network Store Stocking Module 120 creates a new User Storefront and stores the selected item data in the new User Storefront Store Database 152, in an embodiment the User Storefront may be a website which the Admin Network Store Stocking Module 120 creates through a web development portal, which may include an API, in some embodiments the User Storefront is a page or pages within an existing website which are added to the website when a new User Storefront is created, in an embodiment the user is sent materials such as html or php code, and instructions, which assists the user in setting up their own storefront, these instructions may also include a hyperlink to a page within the existing website which contains the hyperlink to the website where the Admin Network Store Stocking Module 120 stores the User Storefront, at step 1014. *The Admin Network Store Stocking Module 120 sends a link to the User Storefront to the User Device Store Setup Module 134, in an embodiment the link is a private link that the user can use to manage the User Storefront, in another embodiment the link directs the user to the same User Storefront that potential buyers would also see, and the user may login in order to manage the User Storefront, in another embodiment the link does not direct the user to the same User Storefront that potential buyers would also see but directs the user to the same User Storefront they would have used to access it if it were in their profile, a user would first register with the system, for example, via email, at step 1016.

Functioning of the User Device Purchase Module 128 will now be explained with reference to FIG. 11. The process begins with the User Device Purchase Module 128 continuously polling for a request from the Admin Network Calculation Module 106 for the User Device User Database 130 data, at step 1100. The User Device Purchase Module 128 receives a request from the Admin Network Calculation Module 106 for the User Device User Database 130 data, at step 1102. Then the User Device Purchase Module 128 sends the User Device User Database 130 data to the Admin Network Calculation Module 106, at step 1104. The User Device Purchase Module 128 connects to the 3rd Party Network 3rd Party Base Module 140, at step 1106. Then the user selects an item from the 3rd Party Network, at step 1108. The user selects the link from the 3rd Party Network, at step 1110. Then the User Device Purchase Module 128 determines if the user entered a code, if not the process continues to sending the data to the 3rd Party Network 3rd Party Base Module 140, at step 1112. If it is determined the user entered a code the User Device Purchase Module 128 sends the code to the 3rd Party Network 3rd Party Base Module 140, at step 1114. The User Device Purchase Module 128 sends the user data to the 3rd Party Network 3rd Party Base Module 140. In some embodiments, the user data may be data to purchase the item such as name, address, billing information, etc. In some embodiments, the user data sent to the 3rd Party Network 3rd Party Base Module 140 may include information from a credit card system. In some embodiments, credit card system may refer to a system that allows cardholders to borrow funds with which to pay for goods and services with the condition that the cardholders pay back the borrowed funds, plus interest, as well as any additional agreed-upon charges, at step 1116.

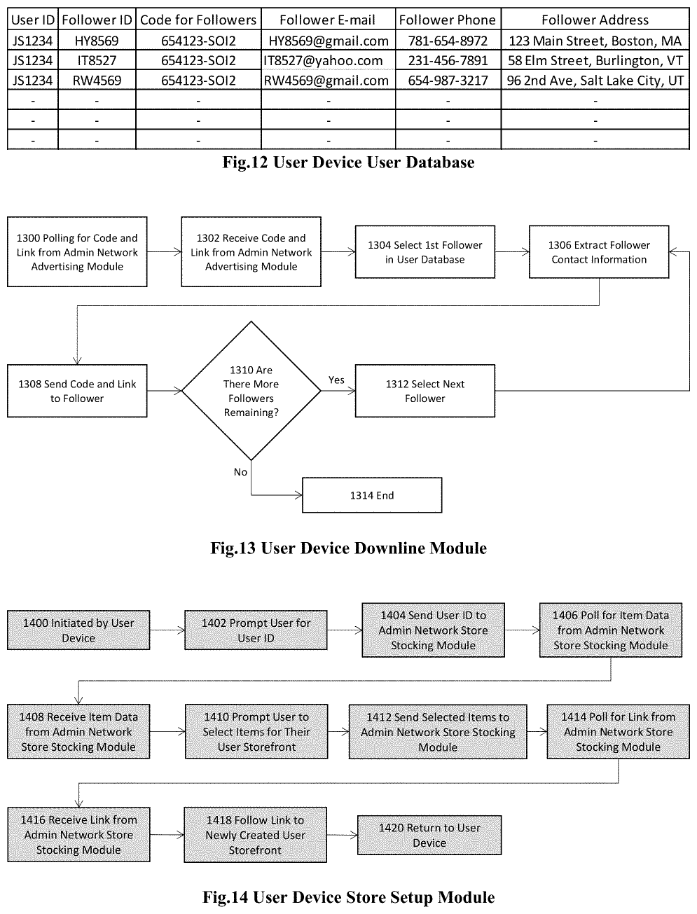

Functioning of the User Device User Database 130 will now be explained with reference to FIG. 12. This figure displays the User Device User Database 130 which contains the user's followers as well as the follower's information. The User Device User Database 130 contains the user's ID, the followers user's ID, the code provided to the followers, the follower's e-mail address, the follower's phone number, the follower's address. In some embodiments, the User Device User Database 130 may contain the follower's social media information such as Twitter, Instagram, Facebook, etc. In some embodiments, the User Database may contain social media plug-ins for enhanced marketing or social media aggregators. In some embodiments, social media plug ins for enhanced marketing may refer to sharing content with other people through social media platforms, for example a share or like button. In some embodiments, the User Device User Database 130 may contain payment information such as bank accounts, credit card information, PayPal, Venmo, etc. In some embodiments, a user ID or ID Enrollment may refer to a participant enrolling in an MLM product tree through an ID, which is unique to each participant in the MLM system. In some embodiments, social medias aggregators may refer to a tool that allows a person to collate posts and updates from many different social media feeds. It creates an organized view of social posts on a specific topic and are often used to display user-generated content on live social walls.

Functioning of the User Device Downline Module 132 will now be explained with reference to FIG. 13. The process begins with the User Device Downline Module 132 continuously polling for the code and the link from the Admin Network Advertising Module 110, at step 1300. The User Device Downline Module 132 receives the code and the link from the Admin Network Advertising Module 110, at step 1302. The User Device Downline Module 132 selects the first follower in the User Device User Database 130, at step 1304. The User Device Downline Module 132 extracts the followers contact information stored in the User Device User Database 130, at step 1306. Then the User Device Downline Module 132 sends the code and link to the follower's contact information. In some embodiments, the code and link may be shared on social media sites, such as Twitter, Instagram, Facebook, etc. for the user's followers to receive the code and link, at step 1308. The User Device Downline Module 132 determines if there are more followers remaining in the User Device User Database 130, at step 1310. If it is determined that there are more followers stored in the User Device User Database 130, the User Device Downline Module 132 selects the next user stored in the User Device User Database 130 and the process returns to step 1306, at step 1312. If the User Device Downline Module 132 determines that there are no more followers remaining in the User Device User Database 130 then the process ends, at step 1314.

Functioning of the User Device Store Setup Module 134 will now be explained with reference to FIG. 14. *The process begins with the User Device Store Setup Module 134 being initiated by the User Device, for example, via the user opening up an application, in an embodiment the User Device Store Setup Module 134 may be grouped with other modules in an application and the user may select which module to initiate from a GUI, at step 1400. *The User Device Store Setup Module 134 prompts the user for their User ID, in some embodiments this may have to login using a username and password or other credentials, in some embodiments more data may be entered, for example, the name of the store to be setup, at step 1402. *The User Device Store Setup Module 134 sends the user ID to the Admin Network Store Stocking Module 120, in embodiments where more than the user ID is entered, the extra data may also be sent to the Admin Network Store Stocking Module 120 or another module on the Admin Network, at step 1404. *The User Device Store Setup Module 134 polls for item data from the Admin Network Store Stocking Module 120, the item data is for items that the user has previously purchased, in some embodiments the user may be able to receive item data for items they have not purchased, at step 1406. *The User Device Store Setup Module 134 receives the item data from the Admin Network Store Stocking Module 120, in some embodiments this data may be stored in a local database on the User Device for later access, at step 1408. *The User Device Store Setup Module 134 prompts the user to select from the received items which items will be sold in their User Storefront, for example, a user may have purchased a drill, table saw, and slow cooker, but may only select to sell the drill and table saw because they want their User Storefront to have a woodworking theme, the user may select items from, for example, a list with checkboxes, at step 1410. *The User Device Store Setup Module 134 sends the user's selected items to the Admin Network Store Stocking Module 120, at step 1412. *The User Device Store Setup Module 134 polls for a link to the newly created User Storefront from the Admin Network Store Stocking Module 120, at step 1414. *The User Device Store Setup Module 134 receives the link from the Admin Network Store Stocking Module 120, which directs the user to the new User Storefront, for example, if the User Storefront is a web site, the link would be a URL, at step 1416. *The User Device Store Setup Module 134 follows the link to the user's new User Storefront, for example, if the link is a URL then the user would be directed to the User Storefront website via a web browser, in some embodiments the User Device Store Setup Module 134 may not immediately follow the link but may send or display the link to the user, at step 1418. *The User Device Store Setup Module 134 returns to the User Device, in an embodiment the User Device Store Setup Module 134 may determine if the user wants to set up another User Storefront and if so return to a previous step, at step 1420.

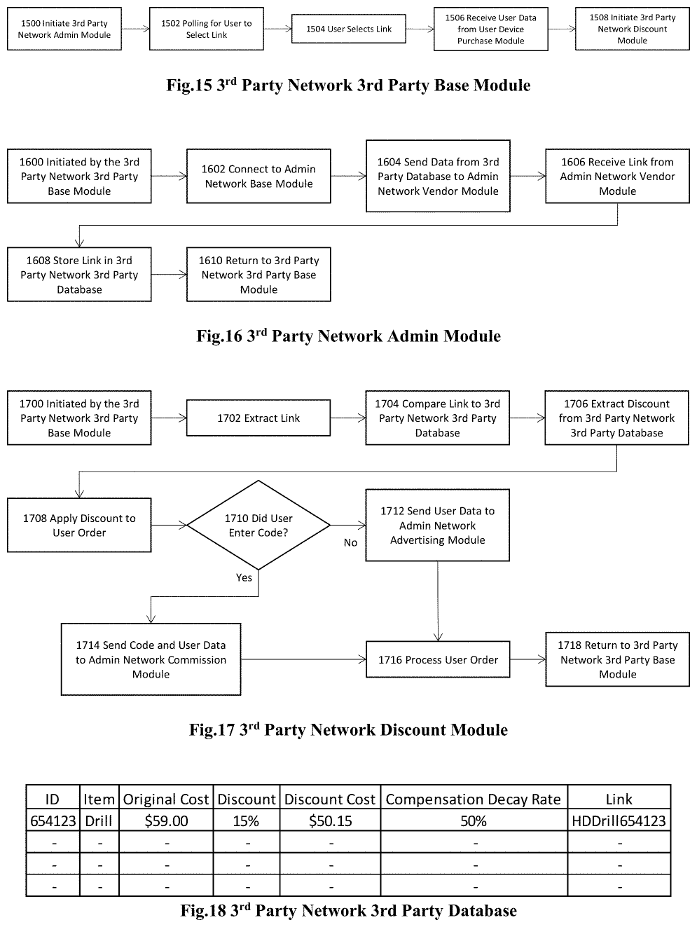

Functioning of the 3rd Party Network 3rd Party Base Module 140″ will now be explained with reference to FIG. 15. The process begins with the 3rd Party Network 3rd Party Base Module 140 initiating the 3rd Party Network Admin Module 142, at step 1500. Then the 3rd Party Network 3rd Party Base Module 140 continuously polls for the user to select the link, at step 1502. The user selects the link on the 3rd Party Network, at step 1504. Then the 3rd Party Network 3rd Party Base Module 140 receives the user data from the User Device Purchase Module 128. In some embodiments, the user data may be data to purchase the item such as name, address, billing information, etc., at step 1506. Then the 3rd Party Network 3rd Party Base Module 140 initiates the 3rd Party Network Discount Module 144, at step 1508.

Functioning of the 3rd Party Network Admin Module 142 will now be explained with reference to FIG. 16. The process begins with the 3rd Party Network Admin Module 142 being initiated by the 3rd Party Network 3rd Party Base Module 140, at step 1600. The 3rd Party Network Admin Module 142 connects to the Admin Network Base Module 104, at step 1602. Then the 3rd Party Network Admin Module 142 sends the 3rd Party Network 3rd Party Database 146 to the Admin Network Vendor Module 114, at step 1604. The 3rd Party Network Admin Module 142 receives the link for the item from the Admin Network Vendor Module 114, at step 1606. Then the 3rd Party Network Admin Module 142 stores the link in the 3rd Party Network 3rd Party Database 146, at step 1608. Then the 3rd Party Network Admin Module 142 returns to the 3rd Party Network 3rd Party Base Module 140, at step 1610.

Functioning of the 3rd Party Network Discount Module 144 will now be explained with reference to FIG. 17. The process begins with the 3rd Party Network 3rd Party Base Module 140 initiating the 3rd Party Network Discount Module 144, at step 1700. The 3rd Party Network Discount Module 144 extracts the link received from the user through the process described in the 3rd Party Network 3rd Party Base Module 140, at step 1702. Then the 3rd Party Network Discount Module 144 compares the extracted link to the 3rd Party Network 3rd Party Database 146, at step 1704. The 3rd Party Network Discount Module 144 extracts the corresponding discount using the extracted link from the 3rd Party Network 3rd Party Database 146, at step 1706. Then the 3rd Party Network Discount Module 144 applies the extracted discount to the user's order, at step 1708. The 3rd Party Network Discount Module 144 determines if the user entered a code, at step 1710. If it is determined that the user did not enter a code the 3rd Party Network Discount Module 144 sends the user data to the Admin Network Advertising Module 110, at step 1712. If it is determined that the user entered a code the 3rd Party Network Discount Module 144 sends the code and the user data to the Admin Network Commission Module 108, at step 1714. Then the 3rd Party Network Discount Module 144 processes the user's order, at step 1716. Then the 3rd Party Network Discount Module 144 returns to the 3rd Party Network 3rd Party Base Module 140, at step 1718.

Functioning of the 3rd Party Network 3rd Party Database 146 will now be explained with reference to FIG. 18. This figure displays the 3rd Party Network 3rd Party Database 146 which contains the information about the items enrolled in the MLM system as well as the link created by the Admin Network Vendor Module 114. The 3rd Party Network 3rd Party Database 146 contains the item ID, the item, the original cost of the item, the discount provided by the 3rd Party for the item, the cost of the item with the discount, the compensation plan decay rate which the 3rd party enters, and the link received from the Admin Network Vendor Module 114. In some embodiments, the 3rd Party Network 3rd Party Database 146 may include the rates of exchange for product returns, marketing materials, airline sky miles, etc. In some embodiments, product returns may refer to a process in which a customer or consumer takes previously purchased product, merchandise, or goods back to the retailer, and in turn receive a refund in the original form of payment, exchange for another item (identical or different), or a store credit. In some embodiments, the information about the product or service may be advertisements to the network, or as seen on TV sales. Advertisements to the network may refer to the advertisement provided to the MLM system from the 3rd party offering a product, good or service. In some embodiments, as seen on TV sales may refer to a generic nameplate for products advertised on television in the United States for direct response mail-order through a toll-free telephone number. In some embodiments, marketing materials may refer to a means of marketing, advertising or promotional materials developed by or for license (or subject to licensee's approval) that promote the sale of the licensed product, including but not limited to, television, radio and online advertising, point of sale materials (e.g. posters, counter-cards), packaging advertising, print media and all audio or video media. In some embodiments, airline sky miles may refer to a loyalty program offered by airlines and/or credit cards. Typically, consumers accumulate a set amount of miles based on how much is spent on a ticket or a credit card and are also known as frequent flyer miles or travel points.

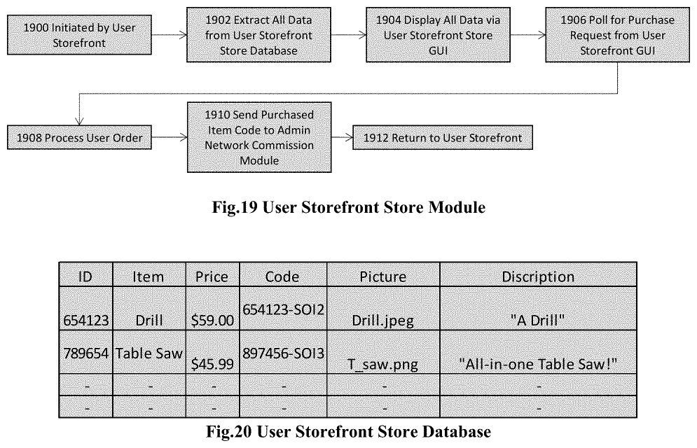

Functioning of the User Storefront Store Module 150 will now be explained with reference to FIG. 19. *The process begins with the User Storefront Store Module 150 being initiated by the User Storefront, for example, when a visitor visits the User Storefront, in some embodiments the User Storefront Store Module 150 may be initiated when the User Storefront is created, at step 1900. *The User Storefront Store Module 150 extracts all data from the User Storefront Store Database 152 which stores the items and information about the items to be displayed in the User Storefront, at step 1902. *The User Storefront Store Module 150 displays the data via the User Storefront Store GUI, for example, the items may be displayed as thumbnails, if pictures are available, with a short description and a price, in some embodiments each item may receive its own portion of the User Storefront, for example, a web page, in an embodiment the appearance of the GUI may be partially or totally customizable by the user, at step 1904. *The User Storefront Store Module 150 polls for a purchase request from the User Storefront Store GUI, for example, a visitor may click on a button that says “Place Order” or “Buy Now”, in an embodiment the User Storefront Store GUI may include an e-commerce shopping cart that allows visitors to the User Storefront to select items for purchase and order all of the selected items at once, at step 1906. *The User Storefront Store Module 150 processes the user's order, for example, by collecting payment and shipping information and using that information to either collect payment and deliver the item, or send pass the information on to a 3rd party, the user in this case being the visitor to the User Storefront who has now become a user via making a purchase and being enrolled in the MLM system, at step 1908. *The User Storefront Store Module 150 sends the referral code associated with the purchased item to the Admin Network Commission Module 108 so that the user who manages the User Storefront is always the upline user of anyone who buys from their User Storefront, this code was extracted in step 1902, in some embodiments the code may only be extracted from the User Storefront Store Database 152 when the purchase is made, in embodiments where multiple items are purchased simultaneously via an e-commerce shopping cart, each code associated with a purchase item is sent, in an embodiment order processing may be handled by an existing e-commerce sales program or party, for example, Shopify, BigCommerce, OpenCart, Volusion, Magneto, or other e-commerce systems which are integrated into website hosting or website building systems, such as Wix, Go Daddy, or Squarespace, at step 1910. *The User Storefront Store Module 150 returns to the User Storefront, in some embodiments the User Storefront Store Module 150 may return to step 1906 and continue to poll for purchase requests, at step 1912.

Functioning of the User Storefront Store Database 152 will now be explained with reference to FIG. 20. *The database contains data on items to be displayed in the store which includes an item ID, For example, 654123, price, for example, $59.00, and referral code, for example, 654123-SOI2, in some embodiments the database may also include marketing materials such as pictures, descriptions, and specs of the items, data from this database is used by the User Storefront Store Module 150 to populate the User Storefront Store GUI with items, in some embodiments the 3rd party retailer or manufacturer of a product may provide these marketing materials which may or may not be required by the 3rd party when the item is displayed, for example, some items may require a trademark in the name or a specific picture where the trademark is visible, whereas other items may be sold as white label items that can be rebranded by the user who manages the User Storefront.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A “single product tree” multi-level marketing method, comprising the steps of,
providing an MLM system with a seller's commission structure, and
providing at least one seller of a product with its associated commission structure, and
providing a plurality of buyers/distributors, and
allowing the at least one first seller to enroll an at least one product to the MLM system, and
allowing at least a first buyer/distributor to purchase the at least one product, and
allowing at least a second buyer/distributor to buy the advertised product, and
*allowing at least the first buyer/distributor to create a store with the at least one product, and
*allowing at least the second buyer/distributor to buy the advertised product from the store, and
*wherein, the seller sets a commission structure for a product, enrolls the product into the MLM system, allowing the first , second and so on purchasers/distributors to purchase and then advertise the product in a store created by a buyer/distributor, and allowing the purchasers/distributors to receive a commission based upon the seller's product commission structure,
